(19) United States
(12) Patent Application Publication
(10) Pub. No.: US 2015/0093607 A1
(43) Pub. Date: Apr. 2, 2015

(54) POWER SUPPLY DEVICE, AND VEHICLE AND STORAGE BATTERY DEVICE EQUIPPED WITH POWER SUPPLY DEVICE

(71) Applicant: Sanyo Electric Co., LTD., Osaka (JP)

(72) Inventors: Tomohisa Kuriyama, Hyogo (JP); Yasuhiro Asai, Hyogo (JP); Tsuyoshi Komaki, Hyogo (JP); Yoshiya Furuie, Hyogo (JP); Hideaki Yano, Hyogo (JP)

(21) Appl. No.: 14/382,781

(22) PCT Filed: Mar. 22, 2013
(86) PCT No.: PCT/JP2013/058215

§ 371 Date: Oct. 23, 2014

(30) Foreign Application Priority Data
Mar. 29, 2012 (JP) 2012-078355

(51) Int. Cl. H01M 2/12

(52) U.S. Cl. CPC H01M 2/1223; H01M 2220/10; H01M 2220/20
USPC 429/54

(57) ABSTRACT

A power supply device comprises a battery assembly formed by stacking secondary battery cells having safety valves for exhausting gas, end plates being arranged at both end faces of the battery assembly in the stacking direction, a gas duct guiding gas emitted from the safety valves in a prescribed gas exhaust passage, and fixing portions fixing both ends of the gas duct to the end plates in a position where the gas duct faces the safety valves. In a state in which the gas duct is fixed to the end plates in at least one of the fixing portion a fixing opening of a slit is formed extending in the direction parallel to the direction in which the secondary battery cells are stacked, and a fixing member is inserted into the slit fixing opening.

### TECHNICAL FIELD

The present invention relates to a power supply device, a vehicle and a storage battery device equipped with the power supply device.

### BACKGROUND ART

A power supply device having plural battery cells is used as a power source device installed in an electric vehicle such as a hybrid vehicle, an electric vehicle, or a home or industrial power storage. The battery cell used in such a power supply device has an exterior container made of metal. A battery assembly is formed by stacking the battery cells interposing a separator therebetween. And end plates are arranged at both end faces of the battery assembly, accordingly the battery assembly is sandwiched and fixed between the end plates.

In order to exhaust gas at the time of rising in the internal pressure of the exterior container by a high temperature or the like, each battery cell has a safety valve. In order to emit and guide such gas safely, the safety valve and a duct are connected with consecutive space (see, for example, patent literature 1). Further a new fixing structure of a gas duct which is not disclosed in patent literature 1 is reviewed by the inventers. As shown in an exploded perspective view of FIG. 22, a gas duct 212 is connected airtight to each safety valve on the upper surface of the battery assembly 210. Such a gas duct 212 is made of resin, both ends have screw holes 213 for fixing. End plates 214 have screw holes 215, and the gas duct 212 is fixed to the end plates 214 by fixing screws 216.

Further, in the battery cell, when it is quickly charged or discharged or at high temperature, rising in the internal pressure happens by the reason of some abnormality. At this time, the exterior container of the battery cell is expanded, and the length of the battery assembly in the stacking direction is temporarily increased. Accordingly, as shown in FIG. 23(a), (b), the end plate 214 is pulled in the expansion direction, but as the gas duct 212 is made of hard material and its full length does not change. As a result, as the fixing screw 216 pulls the screw hole 215, the end of the gas duct 212 fixed to the end plate 214 is torn up or split, and damaged. The above is thought. In this state, fixing of the gas duct 212 and the battery assembly is damaged, so the gas duct 212 is not connected airtight to the safe valve. Then the gas from the safety valve leaks

Especially, for the needs of downsizing of the power supply unit in the resent years, there is a tendency that the gas duct is made as small as possible. In addition, as a result of a tendency of simplifying a fixing structure of the gas duct, the strength of connecting becomes weak. Though a countermeasure against such damage is being sought, an effective countermeasure is not found.

### CITATION LIST

### Patent Literature

Patent Literature 1:

Japanese Laid-Open Patent Publication No. 2010-277736

### SUMMARY OF THE INVENTION

The present disclosure is developed for the purpose of solving such drawbacks. One non-limiting and explanatory embodiment provides a power supply device, a vehicle and a storage battery device equipped with the power supply device to avoid damage to the connection between a gas duct and a battery assembly, and to prevent leakage of gas when a safety valve operates.

A power supply device of the first aspect of the present disclosure comprises a battery assembly formed by stacking secondary battery cells having safety valves for exhausting gas, end plates being arranged at both end faces of the battery assembly in the stacking direction, a gas duct guiding gas emitted from the safety valves in a prescribed gas exhaust passage, and fixing portions fixing both ends of the gas duct to the end plates in a position where the gas duct faces the safety valves. In a state in which the gas duct is fixed to the end plates at least one of the fixing portions has a fixing opening of a slit formed extending in the direction parallel to the direction in which the secondary battery cells are stacked, and a fixing member inserted into the fixing opening. Accordingly even though the battery is expanded in the direction in which the secondary battery cells are stacked, the fixing position of the fixing member (a fixing screw) of the fixing portion is moved along the slit. Therefore damage of the fixing portion is avoided, and the gas duct is prevented from coming off from the battery assembly.

In the power supply device of the second aspect of the present disclosure, the fixing opening of the slit is provided to each end of the gas duct. Accordingly at each end of the gas duct damage by the expansion of the battery assembly is avoided, and when the expansion of the battery assembly happens in any end, the expansion can be absorbed.

In the power supply device of the third aspect of the present disclosure, in at least one end of the gas duct a plural of the fixing portions are provided, and the one fixing opening of the slit is provided in each fixing portion, and the plural fixing openings of the slits are parallel to each other. Accordingly the end of the gas duct is fixed in plural positions, then reliability in the fixing structure can be enhanced.

In the power supply device of the fourth aspect of the present disclosure, the fixing opening of the slit has an open end edge of a U-shape in a plan view. Accordingly by the slit having the open end edge, a movement in the expansion direction is not restricted, therefore, damage of the fixing portion is prevented.

In the power supply device of the fifth aspect of the present disclosure, a power supply device comprises plural secondary battery cells. The secondary battery cell comprises an exterior container; a sealing plate closing the exterior container; and a safety valve being able to open a valve provided at the sealing plate for releasing a gas inside the exterior container by opening the valve when the internal pressure of the exterior container rises. Further the power supply device comprises a battery assembly formed by stacking secondary battery cells having safety valves for exhausting gas, end plates being arranged at both end faces of the battery assembly in the stacking direction, a gas duct guiding gas emitted from the safety valves in a prescribed gas exhaust passage, and fixing portions fixing both ends of the gas duct to the end plates in a position where the gas duct faces the safety valves. And in a state in which the gas duct is fixed to the end plates at least one of the fixing portions has a fixing opening of a slit formed extending in the direction parallel to the direction in which the secondary battery cells are stacked, and a fixing member inserted into the fixing opening. Accordingly even though the battery is expanded in the direction in which the secondary battery cells are stacked, the fixing position of the fixing member (a fixing screw) of the fixing portion is moved along the slit. Therefore damage of the fixing portion is avoided, and the gas duct is prevented from coming off from the battery assembly.

A vehicle of the sixth aspect of the present disclosure is equipped with the above power supply unit.

A storage battery unit of the seventh aspect of the present disclosure is equipped with the above power supply unit.

### BRIEF DESCRIPTION OF DRAWINGS

FIG. 1 is a perspective view of a power supply unit according to one embodiment.

FIG. 2 is a perspective view from the rear side of the power supply unit of FIG. 1.

FIG. 3 is an exploded perspective view in a state in which a gas duct is removed from the power supply unit of FIG. 1.

FIG. 4 is an exploded perspective view from the rear side of the power supply unit of FIG. 3.

FIG. 5 is an exploded perspective view in a state in which the power supply unit of FIG. 3 is further disassembled.

FIG. 6 is a perspective view of a secondary battery cell of FIG. 5.

FIG. 7 is a perspective view of a gas duct of FIG. 5.

FIG. 8 is a perspective view from the bottom face side of the gas duct of FIG. 7.

FIG. 9 is a plan view of the power supply unit of FIG. 1.

FIG. 10 is a vertical sectional view along a line X-X in the power supply unit of FIG. 9.

FIG. 11(a) is a schematic plan view in the power supply unit of FIG. 9, FIG. 11(b) is a schematic plan view in a state of a battery assembly being expanded from the state of FIG. 11(a).

FIG. 12 is an enlarged plan view of the fixing portion of the gas duct in FIG. 11(a).

FIG. 13 is an enlarged plan view of the fixing portion of the gas duct in FIG. 11(b).

FIG. 14 is a plan view of a modification in the fixing portion of the gas duct.

FIG. 15 is a plan view of another modification in the fixing portion of the gas duct.

FIG. 16 is a plan view of further other modification in the fixing portion of the gas duct.

FIG. 17 is a plan view of further other modification in the fixing portion of the gas duct.

FIG. 18 is a plan view of further other modification in the fixing portion of the gas duct.

FIG. 19 is a block diagram showing one explanatory embodiment of a hybrid car driven by an engine and a motor in which the power supply device is installed.

FIG. 20 is a block diagram showing one explanatory embodiment of an electric car driven only by a motor in which the power supply device is installed.

FIG. 21 is a block diagram showing one explanatory embodiment of a storage battery device using the power supply device.

FIG. 22 is an exploded perspective view illustrating a state of disassembling a gas duct from a power supply unit.

FIG. 23(a) is a schematic partial enlarged plan view illustrating a connecting portion of the gas duct and the battery assembly shown in FIG. 22, and FIG. 23(b) is a schematic partial enlarged plan view illustrating damage to the connection between the gas duct and the battery assembly by the expansion of the battery assembly shown in FIG. 23(a).

### DESCRIPTION OF EMBODIMENTS

Hereinafter, the embodiment of the present invention will be described referring to drawings. However, the following embodiments illustrate a power supply unit, and a vehicle and a storage battery device equipped with this which is aimed at embodying the technological concept of the present invention, and the present invention is not limited to the power supply unit, and a vehicle and a storage battery device equipped with this described below. However, the members illustrated in Claims are not limited to the members in the embodiments. It is noted that the magnitude or positional relation of the members illustrated in each diagram is sometimes grandiloquently represented, in order to clarify the description. Furthermore, in the description below, identical names and reference numbers represent identical or homogeneous members, and detailed descriptions are appropriately omitted. Moreover, mode may be applied where each element constituting the present invention constitutes a plurality of elements with the use of the same member, thereby serving the plurality of elements with the use of one member, or, in contrast, mode may be realized where a function of the one member is shared by a plurality of members.

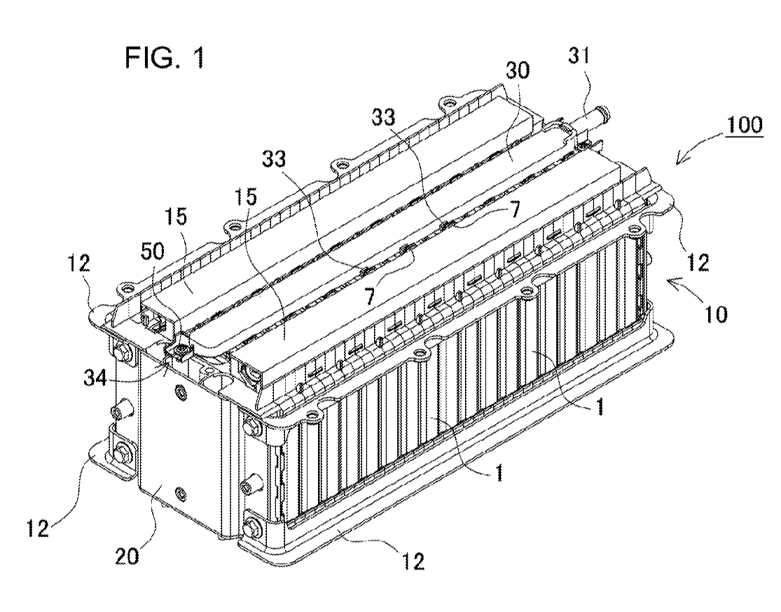

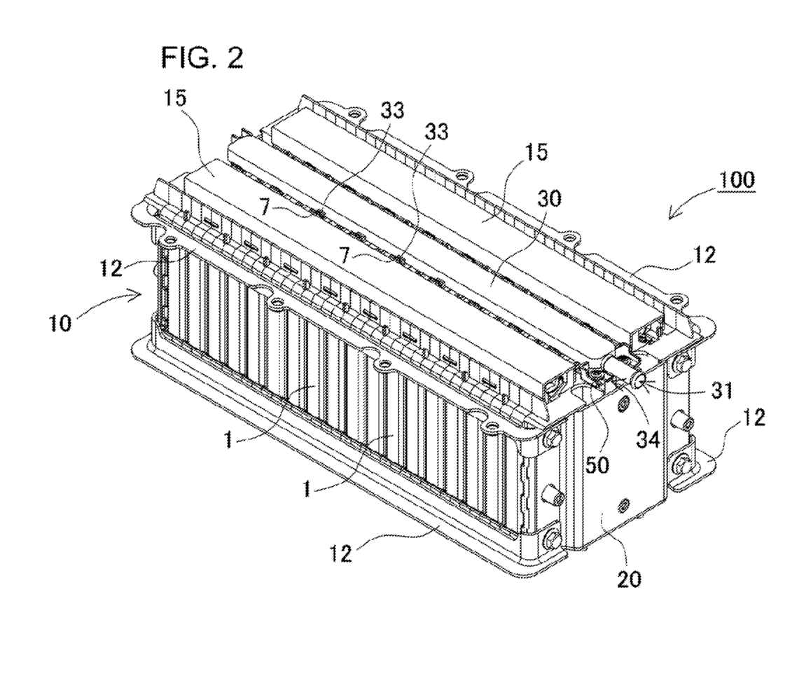

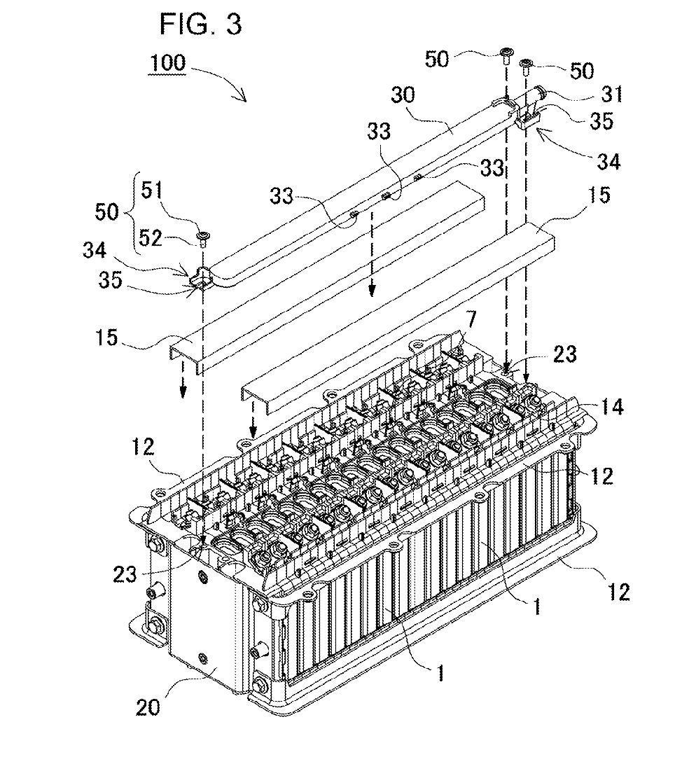

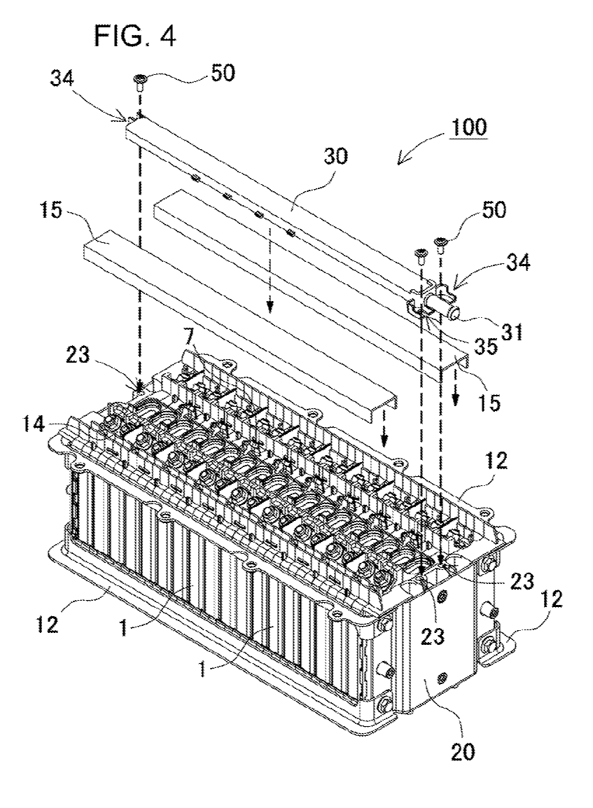

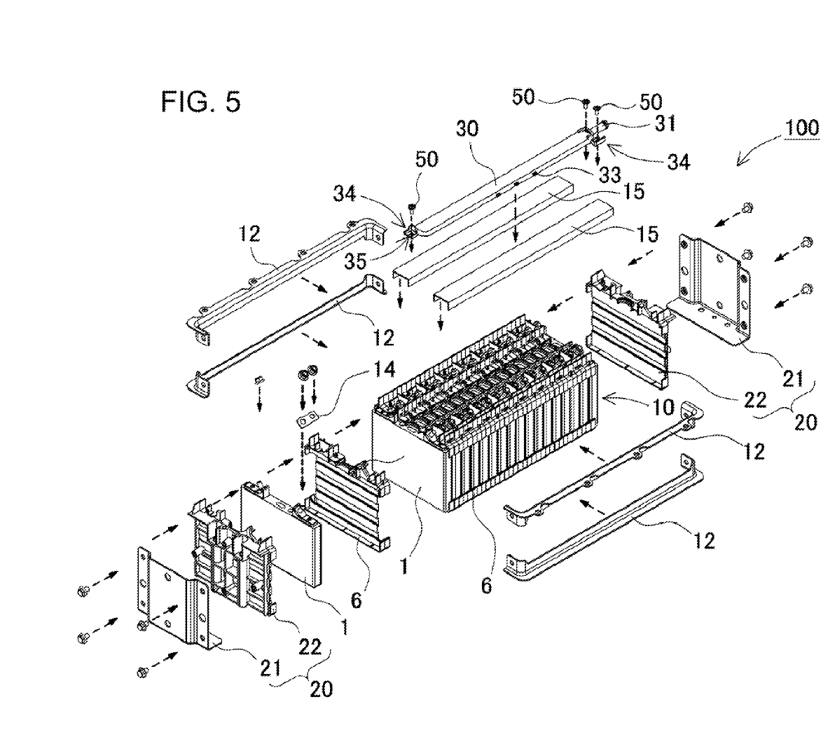

The example of the power supply unit for the vehicle as one embodiment of the power supply unit is explained below using FIG. 1 to FIG. 5. In those figure, FIG. 1 is a perspective view of a power supply unit according to one embodiment, FIG. 2 is a perspective view from the rear side of the power supply unit of FIG. 1, FIG. 3 is an exploded perspective view in a state in which a gas duct is removed from the power supply unit of FIG. 1, FIG. 4 is an exploded perspective view from the rear side of the power supply unit of FIG. 3, FIG. 5 is an exploded perspective view in a state in which the power supply unit of FIG. 3 is further disassembled. This power supply unit 100 has a box shape shown in perspective views shown in FIG. 1, FIG. 2. By plural power supply units 100 being electrically connected in series or parallel, the power supply units has a large capacity, a large output. As shown in exploded perspective views of FIG. 3, FIG. 4, the power supply unit 100 comprises a battery assembly 10 formed by stacking secondary battery cells 1, and a gas duct 30. The gas duct 30 and a safety valve 3 of each secondary battery cell 1 are connected with consecutive space.

### (Battery Assembly 10)

As shown in an exploded perspective view of FIG. 5, the plural secondary battery cells 1 are stacked interposing an insulating separator 6 between the cells 1. End plates 20 are arranged at both end faces of the battery assembly 10. Such battery assembly 10 is block shaped. The separator 6 is made of resin having the excellent insulation properties to prevent conduction between exterior containers 2 of the adjacent cells 1. If necessary, in order to constitute air conduit in which cooling air flows between the cells 1, the surface of the separator 6 can be made uneven.

### (Bind Bar 12)

The end plates 20 at both end faces are bound by bind bars 12. The bind bars 12 are disposed at the side face of the battery assembly 10, fixed to the end plates 20 by screw. In this embodiment, the two bind bars 12 are provided at each of the left and right side faces of the battery assembly 10 in spaced relationship with each other vertically, and fixed to the end plates 20 at four points. Further, the position of the bind bars 12 is not limited to the side face, for example, the bind bars 12 can be fixed to the upper face or the like. The bind bar 12 is made by a metal board being bent. Accordingly the battery assembly 10 is sandwiched and firmly fixed to the end plates 20 bound by the bind bars 12. The adjacent cells 1 are electrically connected by a bus bar 14. And covers 15 cover the bus bars 14 on the upper face of the battery assembly 10. In addition, if necessary, a cooling plate for cooling is disposed on the under face of the battery assembly 10. The cooling plate and the battery assembly 10 are fixed, for example, by a bolt which penetrates the end plate.

### (Secondary Battery Cell 1)

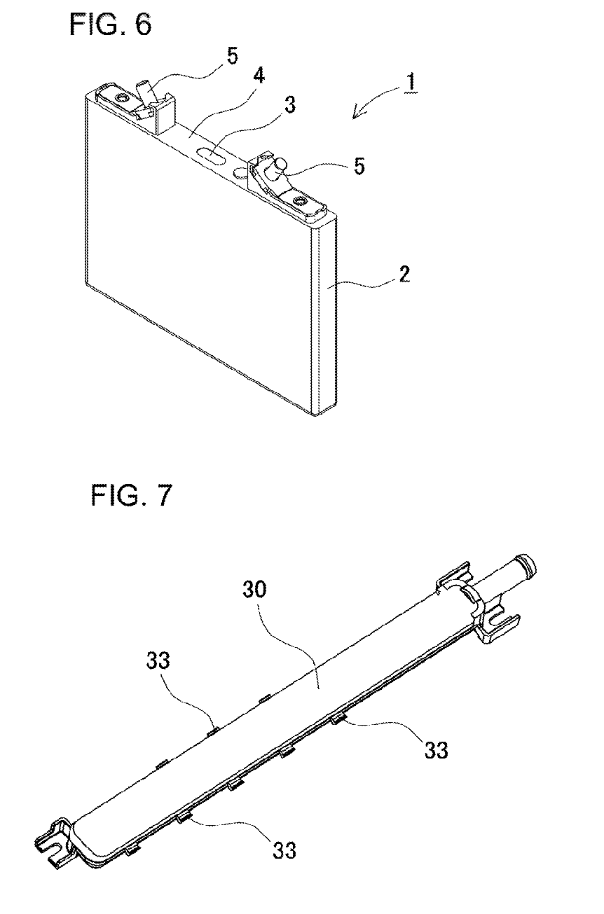

As shown in a perspective view of FIG. 6, the secondary battery cell 1 uses a thin type of the exterior container 2 in which its thickness is small than its breadth of the upper side, in other word, having a thick rectangular board shape. This exterior container 2 has an approximately box shape of chamfering at its four corners. A sealing plate 4 seals the upper surface of the exterior container 2, and a couple of electrode terminals 5 are projected from the sealing plate 4, and the safety valve 3 is provided between the electrode terminals 5 in the sealing plate 4. The safety valve 3 is constituted so as to exhaust gas by opening a valve at the time of rising in the internal pressure of the exterior container 2 equal to or more than a prescribed value. By opening the safety valve 3, rising of the internal pressure can be stopped. Here, in order to effectively guide exhaust gas emitted from the safety valves 3, the secondary battery cells 1 are stacked such that the safety valves 3 are provided on one surface of the battery assembly 10 (the upper surface in this embodiment).

The batteries that serve as the secondary battery cells 1 are rechargeable batteries such as lithium ion batteries, nickel hydride batteries, or nickel cadmium batteries. In particular, when thin outline lithium ion batteries are used, the power source device has the characteristic that high charge capacity per overall volume can be attained.

By a large current of charging or discharging in such secondary battery, it happens that the internal gas pressure rises. When the safety valve 3 is opened and gas is exhausted, a gas exhaust passage guiding the gas in a prescribed passage is provided in the power supply unit incorporating the secondary battery such that the gas does not leaks from the undesired portion. Concretely, the gas duct 30 which partially constitutes the gas exhaust passage is disposed on the upper surface of the battery assembly 10.

### (Gas Duct 30)

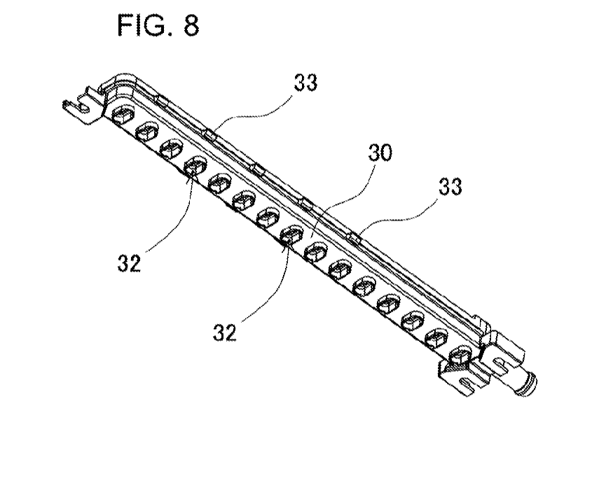

The gas duct 30 is fixed by fixing screws 50 to the upper surface of the battery assembly 10 in a position where the gas duct 30 faces the safety valves 3 so as to guide gas emitted from the safety valves 3 in the prescribed gas exhaust passage. The gas duct 30 is designed to have an enough strength preventing destruction or damage by emitted gas having high pressure or high temperature, and preferably made of resin which is excellent in heat-resisting property, chemical resistance. The gas duct 30 in this embodiment is made of polybutylene terephthalate. But the gas duct can be made of metal which is excellent in hardness, for example, stainless steel. As shown in perspective views of FIG. 7 and FIG. 8, the gas duct 30 has a hollow box shape, and a connecting opening 31 is provided at one end of the gas duct 30 as shown in FIG. 9. In addition, consecutive space openings 32 are provided at the bottom surface of the gas duct 30 in order that the gas duct 30 and the safety valve 3 of each secondary battery cell 1 are connected with consecutive space. The consecutive space opening 32 and the safety valve 3 are connected airtight by using a sealing member (not shown in figures) or the like. The sealing member can be a sheet shape having elasticity, be made of resin, for example, silicone or the like. In addition, the connecting opening 31 is connected airtight to the gas exhaust passage (not shown in figures) with consecutive space. And though the gas exhaust passage the gas emitted from the gas valves 3 is safely exhausted outside.

Here, the above embodiment has the configuration in which the gas is exhausted outside, but the gas duct is not limited to the configuration in which the gas is exhausted outside. The gas duct prevents the gas exhaust toward an undesired portion. In a configuration of a power supply unit, a configuration of preventing a gas exhaust toward an electric circuit board which causes short-circuits can be available. Concretely a configuration in which a power supply unit is disposed outside the vehicle, a configuration in which a power supply unit is covered by an airtight case or the like can be available to prevent the gas exhaust toward the electric circuit board. Namely, the gas exhaust passage does not necessarily need to be shapes like a pipe shape, and it includes a guide member to regulate a gas flow.

In addition, in the above embodiment, the gas duct is disposed on the upper surface of the battery assembly, but depending on a position of the safety valve the gas duct can be disposed on the side surface or the like other than the upper surface of the battery assembly. Namely the gas duct is disposed in a position where the gas duct faces the safety valves 3 of each secondary battery cell 1 on a surface of the battery assembly.

Further in order to fix the middle portion of the gas duct to the battery assembly 10, hook portions 7 are provided at the upper edges of the separators 6. On the other, as shown in FIG. 5, FIG. 7 or the like, plural duct engaging boards 33 are provided in spaced relationship with each other on the side surface of the duct 30. The duct engaging board 33 is disposed in a position corresponding to the hook portion 7. By the duct engaging board 33 being engaged with the hook portion 7, the gas duct 30 is fixed in the middle of the gas duct 30 to the battery assembly 10. Therefore, by a gas pressure emitted from the gas valve 3, the gas duct 30 is prevented from being pushed upward and coming off.

Here in this embodiment, some of the separators 6 and the gas duct 30 are fixed by engaging structure. The fixing structure is not limited to this one, for example, all separators can be fixed to a gas duct. Furthermore, the fixing structure is not limited to the engaging structure, the other structure of gluing, welding, or the like can be available. In addition, the gas duct 30 made of resin in this embodiment can be easily molded. For example, the gas duct 30 and an exhaust pipe having the connecting opening 31 can be integrally molded. Further by engaging structure of the hook portion 7 and the duct engaging boards 33, the gas duct 30 is held, and the gas duct and the sealing member tightly contact each other. Therefore the hook portion 7 and the duct engaging board 33 are easily engaged, then assembling the power supply unit is efficiently carried out.

### (End Plate 20)

The end plate 20 comprises an end separator 22 made of resin, and the metal plate 21 made of metal. Accordingly the end separator 22 is insulated from the secondary battery cell 1 at the end, and it enhances the mechanical strength at the time of the bind bars 12 being connected to the metal plate 21. Here the end plate does not necessarily need to be the divided structure. If the end plate has the appropriate mechanical strength and insulation property, integral resin or metal structure can be available.

End side screw holes 23 into which fixing screws 50 connecting the gas duct 30 are screwed are opened on the upper surface of the end separator 22. In the embodiment shown in perspective views of FIG. 3 and FIG. 4, two of the end side screw holes 23 at approximate middle of each end plate 20 are opened, and screw grooves are formed inside them. In addition, as the end side screw hole an insert nut can be available.

### (Fixing Portion 34)

Therefore, fixing portions 34 are located at both ends of the gas duct 30 being fixing to the end plates 20. The fixing portions 34 comprises slits 35, and the fixing screws 50. In such way, the middle portion of the gas duct 30 is fixed to the separators 6, and both ends of the gas duct 30 are fixed to the end plates 20. Therefore this connecting or fixing structure is strong. Even though a gas high pressure is emitted from the gas valve 3, the gas duct 30 is prevented from being pushed upward and coming off. Especially the separators 6 are made of resin, and the hook portions 7 are connected to the gas duct 30 by the hook structure. So the connecting strength by the hook structure is limited. However connecting by screw at both ends of the gas duct 30 has strong connecting or fixing strength, its reliability can be enhanced. Here, in this disclosure, screw or connection by screw includes rivet or connecting or fixing by rivet. A fixing structure by rivet is not limited to a structure using rivets as the other parts. For example, the following structure is included. A projection is provided on the end plate, and this projection as the fixing member is inserted through a fixing opening, then the tip of the projection is caulked.

### (Slit 35)

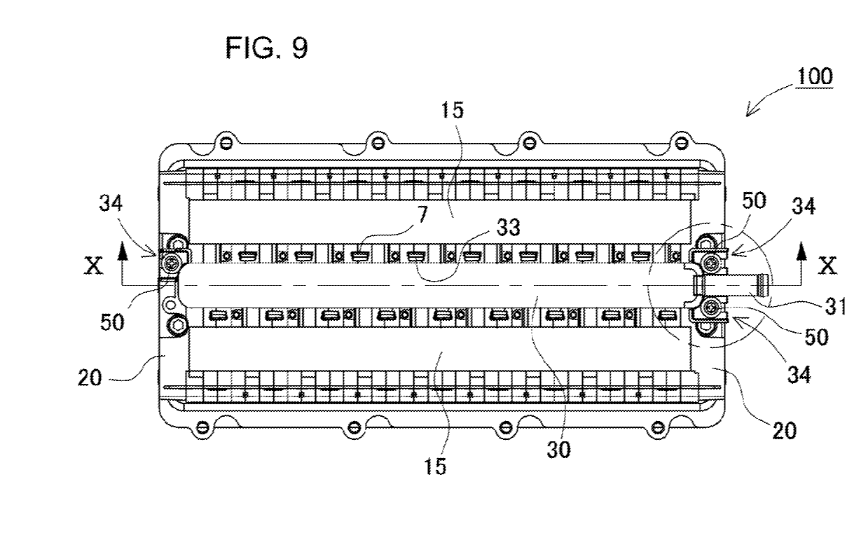

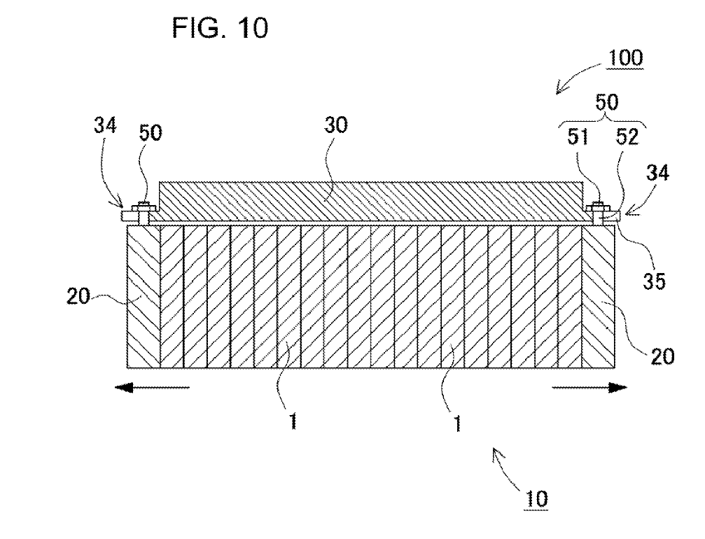

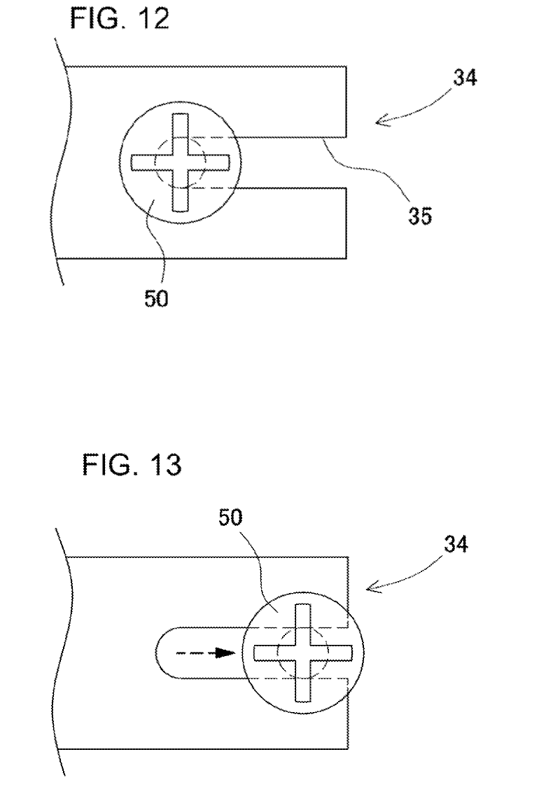

The fixing portions 34 comprises slits 35 as the fixing opening formed extending in the direction parallel to the direction in which the secondary battery cells 1 are stacked, and the fixing screws 50 as a fixing member inserted into the slit. In a state of overlapping the slit 35 and the end side screw hole 23, as shown in a plan view of FIG. 9, the fixing screws 50 are screwed, then the gas duct 30 is fixed to the battery assembly 10. As shown in the plan view of FIG. 9, a sectional view of FIG. 10, the slits 35 are disposed at left and right positions which are approximately symmetrical with respect to the center line of the elongated direction of the end plate 20. Here in FIG. 9 two of the slits 35 are located at the right end, the one slit 35 is located at the left end. In addition the width of each slit 35 is wider than an external diameter of an axle 52, and narrower than an external diameter of a screw head 51 so as to insert the axle 52 of the fixing screw 50 into the slit 35. This structure is shown in an enlarged plan view of FIG. 12 in the fixing screw 50 of the fixing position in the circle of the chain line in FIG. 9.

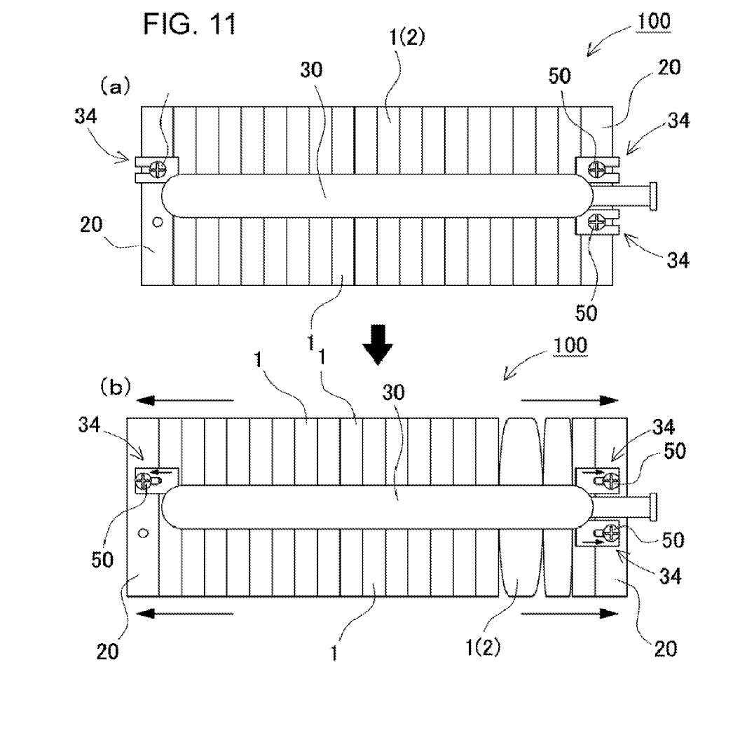

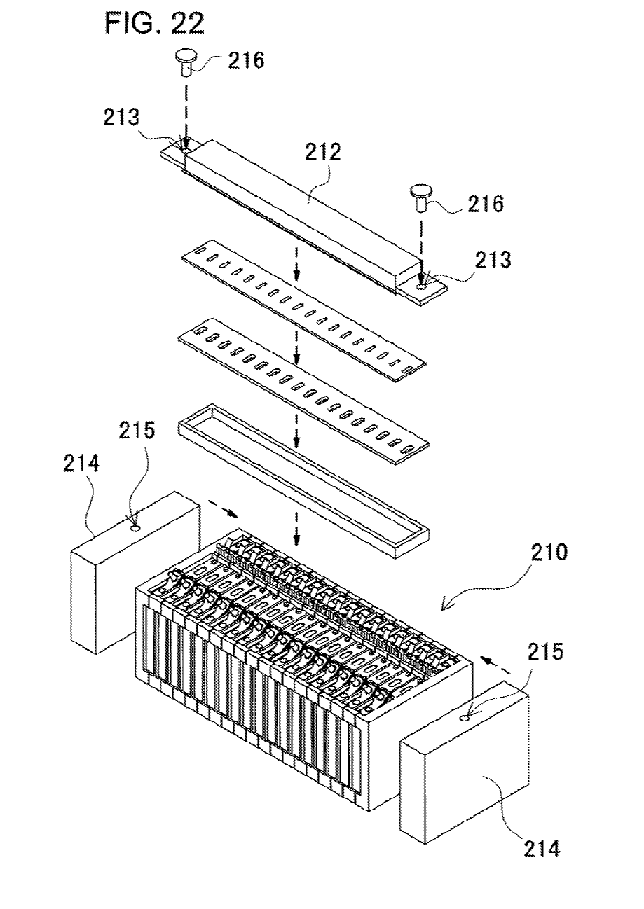

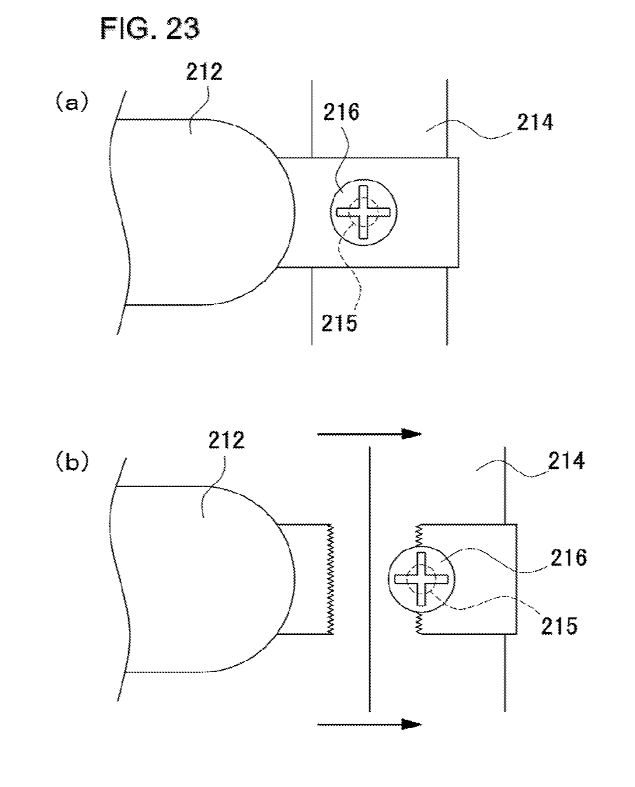

Further, the slit 35 has an open end edge of a U-shape in a plan view. Accordingly, as shown in FIG. 13, by the slit 35 having the open end edge, a movement of the end plate 20 in the expansion direction is not restricted, therefore the damage of the fixing portion 34 is prevented. Namely, as shown in FIG. 10 and FIG. 11, when any one of the secondary battery cells is heated by a quick charging or discharging and the internal gas pressure rises, the exterior container 2 is transformed in the expansion direction. As the battery assembly 10 is sandwiched and fixed to the end plates 20 at the end faces of the battery assembly 10, the exterior containers 2 push the end plates 20 outward, as a result, the end plates 20 are moved outward in the expansion direction. Here as shown in the exploded perspective view of FIG. 22 and the plan view of FIG. 23(a), assuming that the gas duct 30 and the separator are fixed by fixing screws 50 through circle holes penetrating the both ends of the gas duct 30. As shown in FIG. 22(b), the end plates 20 in the expansion direction are pushed by the expansion of the exterior container 2, and the fixing screw 50 is moved. As the result, the portion of the circle hole is broken, and the gas duct 30 is not connected to the end plate 20, so the gas from the safety valve leaks at the connecting portion to the gas duct 30. The gas is not exhausted outside. The above is thought.

So in this embodiment, as mentioned above, by the fixing screw 50 to the slit 35 having the open end edge as shown in FIG. 11(b), even though the fixing position to the fixing screw 50 is moved, it prevents the fixing portion 34 from being torn up or split, and damaged.

As a result, the connection of the gas duct 30 and the end plates 20 is kept, then it enables to guide the gas emitted from the safety valve 3 in the gas duct 30.

As mentioned above, as the slits 35 are disposed in spaced relationship at both ends of the gas duct 30, the gas duct 30 is fixed to the end plates 20 at both ends of the gas duct 30, the connection strength is enhanced. Here in the above embodiment, the gas duct 30 is strongly fixed to the end plates 20 at both ends of the gas duct 30. Instead of this structure, both ends of the gas dust 30 can be fixed by screw to the end separators 22 when its strength is enough.

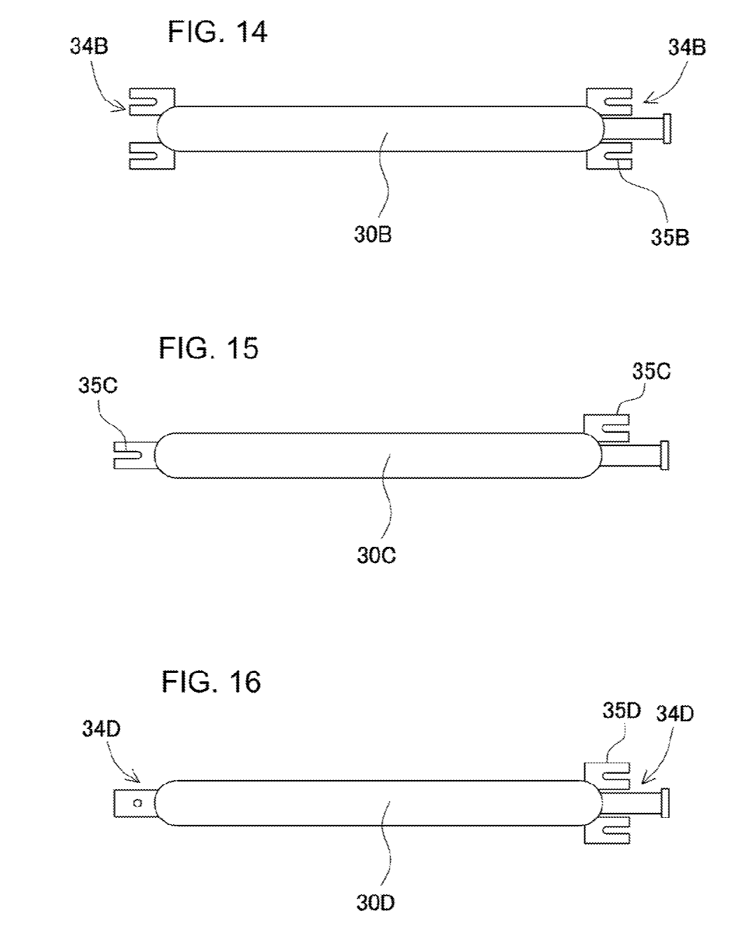

In the embodiment shown in FIG. 7 or the like, the two slits 35 of the fixing portion 34 are located at the one end of the gas duct 30, and the one slit 35 of the fixing portion 34 is located at the other end of the gas duct 30. Here, a structure is not limited to this structure, as shown in a modification of FIG. 14, needless to say, two of slits 35B of fixing portions 34B can be provided at each end of a gas duct 30B. By this structure, as the gas duct 30B is left-right symmetry, the gas duct 30B is attached without distinguish between the left and the right of the gas duct 30B at the time of assembling, therefore an efficiency of working can be enhanced.

Here in the fixing portions the structure is limited to the above embodiment having two of the slits. As shown in FIG. 15, one slit 35C can be available. Further equal to or more than three slits can be also available. Thus the number of the slit is properly changed and determined corresponding to a required strength or a required space.

Further as shown in a gas duct of FIG. 16, a slit 35D is provided at one of fixing portions 34D, a screw hole is provided at the other of the fixing portions 34D. In this structure, as only the fixing peripheral portion (the fixing position) of the slit 35D to the fixing screw can be moved, such movement (=absorbing power) against the expansion is decreased in half. However as the fixing position of the slit 35D of the fixing portions 34D can be moved and absorb against the expansion of the battery assembly, the expansion can be absorbed to a certain extent. Therefore, corresponding to the number of secondary battery cells for usage and an expected expansion, if the slits are provided at both ends, or if the slit is provided at one end can be properly selected.

In addition, in the above embodiment, the slit 35 has the open end edge of the U-shape, but as shown in FIG. 18 the slit of the gas duct 30E can be a slot 36. In this case in order not to damage the ends of the slot 36 by moving of the fixing screw 50, it is necessary that the slot 36 has an enough length in the elongated direction.

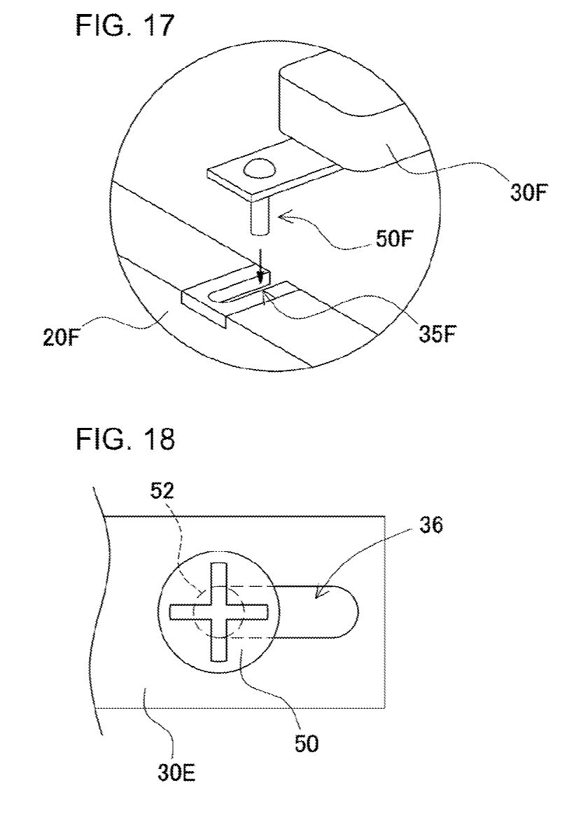

Further in the above embodiment regarding the fixing portion, the fixing opening formed in the gas duct side, the fixing screw fixing the end plate side or the end separator side, the rivet or the like as the fixing structure is explained above. The fixing opening and the fixing member can be changed, then needless to say, it has the same effect. For example, as shown in FIG. 17, the fixing part 50F as the fixing member of a screw, a rivet, or the like is fixed to the end of the gas duct 30F, and a fixing hole 35F of a slit shape as the fixing opening in which the fixing part 50F is inserted is formed. Therefore, the expansion of the battery assembly can be absorbed.

As mentioned above, by using the slit in the fixing portion, the gas duct is firmly fixed by screw to the end plate, and it copes with the expansion of the battery assembly, therefore reliability in the fixing structure can be enhanced.

The aforementioned power supply devices can be used as a power supply for vehicles. The power supply device can be installed on electric vehicles such as hybrid cars that are driven by both an internal-combustion engine and an electric motor, and electric vehicles that are driven only by an electric motor. The power supply device can be used as a power supply device for these types of vehicles.

### (Hybrid Car Power Supply Device)

FIG. 18 is a block diagram showing an exemplary hybrid car that is driven both by an engine and an electric motor, and includes the power supply device. The illustrated vehicle HV with the power supply device includes an electric motor 93 and an internal-combustion engine 96 that drive the vehicle HV, a power supply device 100 that supplies electric power to the electric motor 93, and an electric generator 94 that charges batteries of the power supply device 100. The power supply device 100 is connected to the electric motor 93 and the electric generator 94 via a DC/AC inverter 95. The vehicle HV is driven both by the electric motor 93 and the internal-combustion engine 96 with the batteries of the power supply device 100 being charged/discharged. The electric motor 93 is energized with electric power and drives the vehicle in a poor engine efficiency range, e.g., in acceleration or in a low speed range. The electric motor 93 is energized by electric power that is supplied from the power supply device 100. The electric generator 94 is driven by the engine 96 or by regenerative braking when users brake the vehicle so that the batteries of the power supply device 100 are charged.

### (Electric Vehicle Power Supply Device)

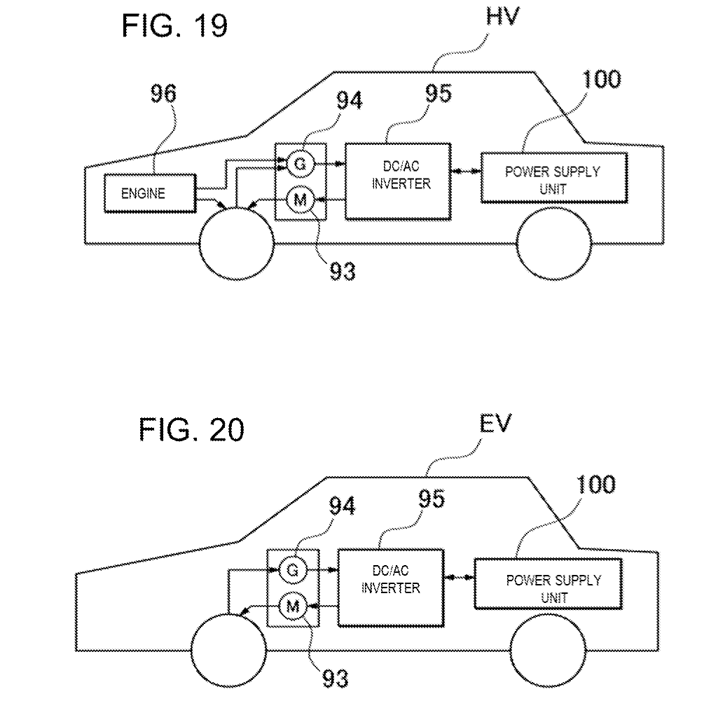

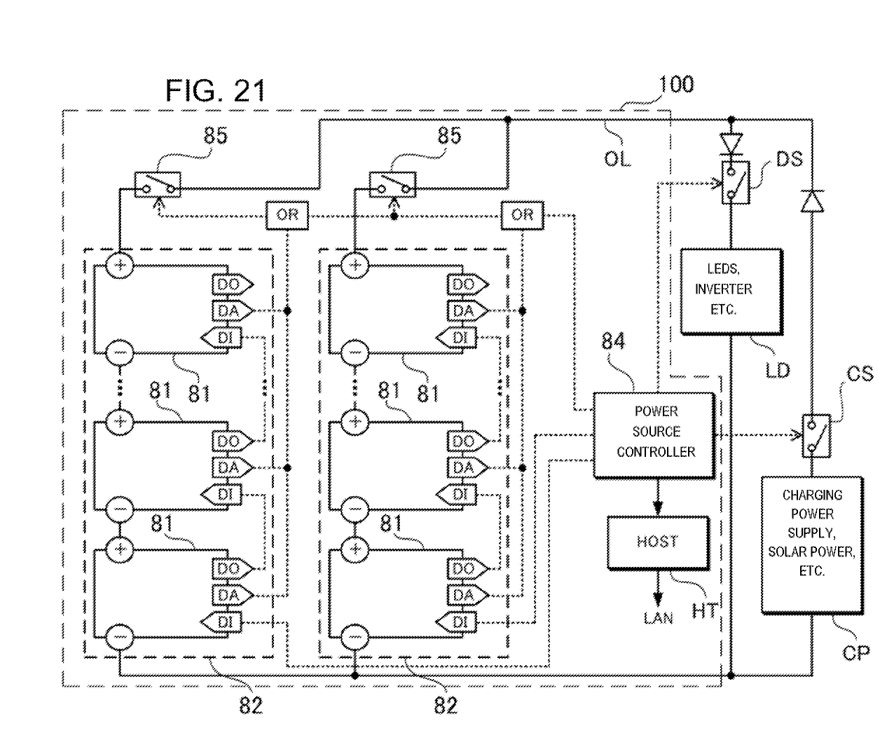

FIG. 19 shows an exemplary electric vehicle that is driven only by an electric motor, and includes the power supply device. The illustrated vehicle EV with the power supply device includes the electric motor 93, which drives the vehicle EV, the power supply device 100, which supplies electric power to the electric motor 93, and the electric generator 94, which charges batteries of the power supply device 100. The electric motor 93 is energized by electric power that is supplied from the power supply device 100. The electric generator 94 can be driven by vehicle EV regenerative braking so that the batteries of the power supply device 100 are charged.

### (Power Storage Type Power Supply Device

The power supply device can be used not only as power supply of mobile unit but also as stationary power storage. For example, examples of stationary power storage devices can be provided by an electric power system for home use or plant use that is charged with sunlight or with midnight electric power and is discharged when necessary, a power supply for street lights that is charged with sunlight during the daytime and is discharged during the nighttime, or a backup power supply for signal lights that drives signal lights in the event of a power failure. FIG. 20 shows an exemplary circuit diagram. This illustrated power supply device 100 includes battery units 82 each of which includes a plurality of battery packs 81 that are connected to each other. In each of battery packs 81, a plurality of rectangular battery cells 1 are connected to each other in serial and/or in parallel. The battery packs 81 are controlled by a power supply controller 84. In this power supply device 100, after the battery units 82 are charged by a charging power supply CP, the power supply device 100 drives a load LD. The power supply device 100 has a charging mode and a discharging mode. The Load LD and the charging power supply CP are connected to the power supply device 100 through a discharging switch DS and a charging switch CS, respectively. The discharging switch DS and the charging operation switch CS are turned ON/OFF by the power supply controller 84 of the power supply device 100. In the charging mode, the power supply controller 84 turns the charging operation switch CS ON, and turns the discharging switch DS OFF so that the power supply device 100 can be charged by the charging power supply CP. When the charging operation is completed so that the battery units are fully charged or when the battery units are charged to a capacity not lower than a predetermined value, if the load LD requests electric power, the power supply controller 84 turns the charging operation switch CS OFF, and turns the discharging switch DS ON. Thus, operation is switched from the charging mode to the discharging mode so that the power supply device 100 can be discharged to supply power to the load LD. In addition, if necessary, the charging operation switch CS may be turned ON, while the discharging switch DS may be turned ON so that the load LD can be supplied with electric power while the power supply device 100 can be charged.

The load LD driven by the power supply device 100 is connected to the power supply device 100 through the discharging switch DS. In the discharging mode of the power supply device 100, the power supply controller 84 turns the discharging switch DS ON so that the power supply device 100 is connected to the load LO. Thus, the load LD is driven with electric power from the power supply device 100. Switching elements such as FET can be used as the discharging switch DS. The discharging switch DS is turned ON/OFF by the power supply controller 84 of the power supply device 100. The power supply controller 84 includes a communication interface for communicating with an external device. In the exemplary power supply device shown in FIG. 20, the power supply controller is connected to a host device HT based on existing communications protocols such as UART and RS-232C. Also, the power supply device may include a user interface that allows users to operate the electric power system if necessary.

Each of the battery packs 81 includes signal terminals and power supply terminals. The signal terminals include a pack input/output terminal DI, a pack abnormality output terminal DA, and a pack connection terminal DO. The pack input/output terminal DI serves as a terminal for providing/receiving signals to/from other battery packs and the power supply controller 84. The pack connection terminal DO serves as a terminal for providing/receiving signals to/from other battery packs as slave packs. The pack abnormality output terminal DA serves as a terminal for providing an abnormality signal of the battery pack to the outside. Also, the power supply terminal is a terminal for connecting one of the battery packs 81 to another battery pack in series or in parallel. In addition, the battery units 82 are connected to an output line OL through parallel connection switches 85, and are connected in parallel to each other.

### INDUSTRIAL APPLICABILITY

A power supply device, a vehicle and a storage battery device equipped with the power supply device according to the present invention can be suitably used as power supply devices of plug-in hybrid vehicles and hybrid electric vehicles that can switch between the EV drive mode and the HEV drive mode, electric vehicles, and the like. A vehicle including this power supply device according to the present invention can be suitably used as plug-in hybrid vehicles, hybrid electric vehicles, electric vehicles, and the like. Also, a power supply device according to the present invention can be suitably used as backup power supply devices that can be installed on a rack of a computer server, backup power supply devices for wireless communication base stations, electric power storages for home use or plant use, electric power storage devices such as electric power storages for street lights connected to solar cells, backup power supplies for signal lights, and the like.

### REFERENCE MARKS IN THE DRAWINGS

100: power supply unit
1: secondary battery cell
2: exterior container
3: safety valve
4: sealing plate
5: electrode terminal
6: separator
7: hook portion
10: battery assembly
12: bind bar
14: bus bar
15: cover
20, 20F: end plate
21: metal plate
22: end separator
23: end side screw hole
30, 30B, 30C, 30D, 30E, 30F: gas duct
31: connecting opening
32: consecutive space opening
33: duct engaging board
34, 34B, 34D: fixing portion
35, 35B, 35C, 35D: slit; 35F: fixing hole
50: fixing screw; 50F: fixing part
51: screw head
52: axle
81: battery pack
82: battery unit
84: power supply controller
85: parallel connection switch
93: electric motor
94: electric generator
95: DC/AC inverter
96: engine
210: battery assembly
212: gas duct
213: screw hole
214: end plate
215: screw hole
216: fixing screw
HV, EV: vehicle
LD: load charging; CP: power supply; DS: discharging switch; CS: charging switch
OL: output line; HT: Host device
DI: pack input/output terminal; DA: pack abnormality output terminal; DO: pack connection terminal

1. A power supply device comprising:
a battery assembly formed by stacking secondary battery cells having safety valves for exhausting gas;
end plates being arranged at both end faces of the battery assembly in the stacking direction;
a gas duct guiding gas emitted from the safety valves in a prescribed gas exhaust passage; and
fixing portions fixing both ends of the gas duct to the end plates in a position where the gas duct faces the safety valves
wherein, in a state in which the gas duct is fixed to the end plates, at least one of the fixing portions has a fixing opening of a slit formed extending in the direction parallel to the direction in which the secondary battery cells are stacked, and a fixing member inserted into the fixing opening.

2. The power supply device according to claim 1,
wherein the fixing opening of the slit is provided to each end of the gas duct.

3. The power supply device according to claim 1,
wherein in at least one end of the gas duct a plural of the fixing portions are provided, and the one fixing opening of the slit is provided in each fixing portion, and the plural fixing openings of the slits are parallel to each other.

4. The power supply device according to claim 1,
wherein the fixing opening of the slit has an open end edge of a U-shape in a plan view.

5. A power supply device comprising:
plural secondary battery cells comprising
an exterior container,
a sealing plate closing the exterior container, and
a safety valve being able to open a valve provided at the sealing plate for releasing a gas inside the exterior container by opening the valve when the internal pressure of the exterior container rises;
a battery assembly formed by stacking secondary battery cells having safety valves for exhausting gas;
end plates being arranged at both end faces of the battery assembly in the stacking direction;
a gas duct guiding gas emitted from the safety valves in a prescribed gas exhaust passage; and
fixing portions fixing both ends of the gas duct to the end plates in a position where the gas duct faces the safety valves,
wherein, in a state in which the gas duct is fixed to the end plates, at least one of the fixing portions has a fixing opening of a slit formed extending in the direction parallel to the direction in which the secondary battery cells are stacked, and a fixing member inserted into the fixing opening.

6. A vehicle quipped with the power supply unit according to claim 1.

7. A storage battery unit equipped with the power supply unit according to claim 1.

8. A vehicle quipped with the power supply unit according to claim 5.

9. A storage battery unit equipped with the power supply unit according to claim 5.
